(19) United States
(12) Patent Application Publication
(10) Pub. No.: US 2013/0193069 A1
(43) Pub. Date: Aug. 1, 2013

(54) Fluid Treatment System

(71) Applicants: Brian L Aiken, East Aurora, NY (US); Blair M. Aiken, Cooperstown, NY (US)

(72) Inventors: Brian L Aiken, East Aurora, NY (US); Blair M. Aiken, Cooperstown, NY (US)

(21) Appl. No.: 13/751,061

(22) Filed: Jan. 26, 2013

Related U.S. Application Data
(60) Provisional application No. 61/591,653, filed on Jan. 27, 2012.

(51) Int. Cl. C02F 3/32

(52) U.S. Cl. CPC C02F 3/322
USPC 210/615; 210/151

(57) ABSTRACT

A system for treating an effluent includes a cap assembly and a reactor module. The cap assembly captures the effluent discharge from a source. The reaction module includes a reaction chamber housing a substrate and an illumination device. In operation, the effluent is drawn into the cap assembly and directed downstream, into the reactor module. The effluent flows over the substrate, causing adsorption of bacteria to substrate. Additionally, the illumination device is selectively activated to direct photons toward the effluent for selected periods of time. With this configuration, a biomass formed of algae develops in the reaction chamber (e.g., on the substrate). The biomass is effective to reduce the amount of contaminates within the effluent.

### CROSS REFERENCE TO RELATED APPLICATIONS

The present application claims priority to provisional application 61/591,653, entitled “Geofluid Treatment System Including Modular Bioreactors” and filed on 27 Jan. 2012, the disclosure of which is hereby incorporated by reference in its entirety.

### FIELD OF THE INVENTION

present invention relates generally to a treatment system for effluent such as geothermal fluid and, in particular, to a treatment system including modular bioreactors.

### BACKGROUND OF THE INVENTION

Geologic formations such as shale and coal bed methane formations contain large quantities of oil or gas, but have a poor flow rate due to low permeability. Hydraulic fracturing—“fracking”—stimulates wells drilled into these geologic formations. In the fracking process, a well is drilled and steel pipe casing is inserted in the well bore. The casing is perforated within the target zones containing oil or gas. Fracturing fluid (e.g., a mixture of water, proppants (e.g., sand or ceramic beads), and chemicals) is pumped into the rock or coal formation, where it flows through the perforations into the target zones. The fluid is continuously injected into the target area until the target area can no longer absorb the fluid, and the resulting pressure causes the formation to crack or fracture. Once the fractures are created, injection ceases and waste water such as flowback (fracturing fluid injected into a gas well that returns to the surface) or produced water (water trapped in underground formations that is brought to the surface along with oil or gas) is released as surface discharge. The proppants remain in the target formation to hold the fractures open.

In addition, geothermal companies have begun to generate electricity using geothermal energy harnessed from abandoned oil and gas wells via geothermal fracking (e.g., fracturing of a zone of hot rocks in order to make them water permeable and thus able to produce hot water or steam).

This wastewater may contain potentially harmful pollutants, including salts, organic hydrocarbons (sometimes referred to simply as oil and grease), inorganic and organic additives, and other chemicals. These pollutants can be dangerous if they are released into the environment or if people are exposed to them. Given the high volume of wastewater produced during the fracking process, disposal and treatment of surface discharge present waste management challenges for well site operators. Typically, the effluent is initially stored in a retention pond until the produced water can be delivered offsite for treatment and disposal. A typical well may require a fleet of 5,000-gallon tanker trucks hauling up to 20 truckloads of contaminated water per day for up to three months for one well. This process is not only expensive, but also creates increased environmental risks that are inherent in storing and transferring contaminated material.

Thus it would be desirable to provide a system that treats water at the well site, reduces the cost of disposal, and minimizes the environmental risk by, among other things, eliminating the need to transport the contaminated effluent.

### SUMMARY OF THE INVENTION

The present invention is directed toward a system for treating an effluent such as a geothermal surface discharge or other wastewater. The system includes a cap assembly and a bioreactor assembly in fluid communication with the cap assembly. The cap assembly captures the effluent exiting, e.g., geologic material. The bioreactor assembly includes one or more bioreactor modules housing a substrate and an illumination device. In operation, the effluent is drawn into the cap assembly and directed into the reactor module. The effluent flows over the substrate, causing the adsorption of bacteria to the substrate. The illumination device is selectively activated to direct photons toward the effluent for selected periods of time. With this configuration, an algal biomass develops in the bioreactor module (e.g., on the substrate and in the tank). The biomass is effective to reduce the amount of contaminates within the effluent, sequestering contaminants and/or consuming contaminants to feed its growth. The biomass may be periodically harvested from the bioreactor module and optionally processed to extract any desired byproducts. The reactor modules are modular, and may be linked in parallel or in series to alter the treatment capacity or functioning of the system.

### BRIEF DESCRIPTION OF THE DRAWINGS

FIG. 1 illustrates a perspective view of a treatment system in accordance with an embodiment of the invention, with selected portions removed or made transparent for clarity.

FIGS. 2A and 2B illustrate perspective views of a bioreactor module in accordance with an embodiment of the invention.

FIG. 3 illustrates a rear plan view of bioreactor module in accordance with an embodiment of the invention.

FIG. 4A illustrates a perspective view of a dispersion device in accordance with an embodiment of the invention.

FIG. 4B illustrates a perspective cleansing device in accordance with an embodiment of the invention.

FIG. 5A illustrates a front plan view substrate in accordance with an embodiment of the invention.

FIG. 5B illustrates a close-up of a portion of the substrate of FIG. 5A, showing apertures including a raised rib and a deflection ramp.

FIG. 5C illustrates a cross sectional view taken along lines 5C-5C of FIG. 5B.

FIG. 5D illustrates a substrate coupled to a dispersion device in accordance with an embodiment of the invention.

FIG. 6 illustrates a partial view of substrate in accordance with another embodiment of the invention.

FIG. 7A illustrates a partial cross sectional view of a bioreactor unit, showing the substrate supported within a reaction chamber.

FIG. 7B illustrates a schematic showing the operation of the bioreactor module.

FIG. 8 illustrates a perspective view of a treatment system in accordance with another embodiment of the invention, showing a drying device located downstream from the reactor module.

FIG. 9A illustrates a perspective view of a treatment system configuration including a plurality of bioreactor assemblies linked to a single cap assembly.

FIGS. 9B and 9C illustrate side and front views, respectively of the system shown in FIG. 9A.

Like reference numerals have been used to identify like elements throughout this disclosure.

### DETAILED DESCRIPTION OF THE INVENTION

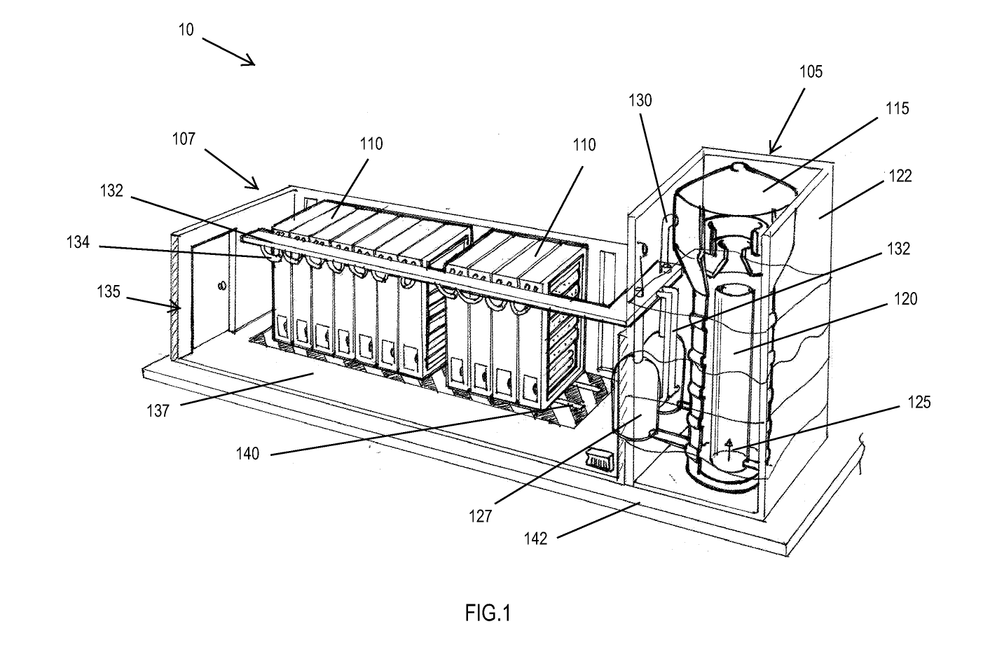

FIG. 1 illustrates an embodiment of the treatment system in accordance with an embodiment of the invention. As shown, the system 10 includes a cap or storage assembly 105 and a bioreactor assembly 107 including one or more bioreactor modules 110 disposed downstream from the cap assembly. The cap assembly 105 is configured to capture an effluent from a source. The effluent, which may have a temperature of about 15° C. to about 43° C. (e.g., 22° C.) includes nutrient-rich effluent such as geothermal fluids, produced water, flowback and wastewater, and other fluids emitted by a source such as a geothermal power plant, a fracking well site, etc. The cap assembly 105 includes a tank or cap 115 surrounding a well column or casing 120 in fluid communication with an effluent. The cap 115, housed in a cap housing 122, defines a cavity within which effluent 125 (indicated by arrow) gathers and/or is stored.

The cap assembly 105 may further include one or more pump units 127 and associated vents 130 that allow for the displacement of air between the casing and the pump column. The pump unit 127 and vent 130 may be any suitable for their described purpose, and may include those utilized in conventional well systems. The pump units 127 direct the fluid into a transport conduit 132, which feeds the bioreactor modules 110 of the bioreactor assembly 107 (discussed in greater detail below). With this configuration, the effluent 125 emitted by a source may be sent directly downstream from the cap assembly 105 to the bioreactor assembly 107, or may be stored for a predetermined period of time within the cap 115.

The effluent 125 directed to the bioreactor assembly 107 may be untreated when discharged from the cap assembly 105. Alternatively, the effluent 125 may be treated prior to being discharged from the cap assembly 105 and/or entering the bioreactor assembly 107. In an embodiment, at least one parameter of the effluent 125 is modified prior to processing by the bioreactor assembly 107. By way of example, the temperature of the effluent 125 may be adjusted. Specifically, if the temperature of the effluent 125 falls below a predetermined value (i.e., if the temperature falls below a value at with algae growth occurs), the effluent may be heated. Alternatively, if the temperature of the effluent 125 is too high (e.g., too high to encourage algae growth), heat may be removed, e.g., via a heat exchanger. In typical configurations, the temperature of the effluent will be approximately 22° C.

Additionally, the effluent 125 may be treated via filtering (e.g., in storage or during transport), settling (e.g., in cap assembly or separate tank), etc. The effluent 125, moreover, may be temporarily stored for a predetermined period of time to permit aerobic and/or anaerobic bacteria present within the effluent to reach a predetermined level. Additionally, nutrients may be added to the stored effluent 125 to enhance bacteria formation. The carbon dioxide level (CO₂) of the effluent 125 may also be modified (e.g., by adding or removing CO₂). In addition, the pH of the effluent 125 may be modified. In still other embodiments, one or more additives effective to alter a parameter of the effluent 125 (e.g., bacteria, chemicals, etc.) may be added.

The effluent 125 may be treated during storage (e.g., while stored within the cap 115) or while flowing from the cap assembly 105 to the bioreactor assembly 107.

The bioreactor assembly 107 includes one or more bioreactor modules 110 stored within a bioreactor assembly housing 135. The bioreactor assembly housing 135 may be any housing suitable for its described purpose. By way of example, the housing 135 may be in the form of a ship container and/or a truck-sized intermodal or freight container (walls of containers partially removed for clarity). By way of specific example, the bioreactor modules 110 may be housed in a standard 10′×10′×40′ shipping container. Accordingly, a single bioreactor assembly housing 135 may house up to 60 bioreactor modules 110. The floor 137 of the housing 135 may be fitted with tracks 140 along which the bioreactor modules 110 are configured to move/slide (the modules include a corresponding connector that slidingly mates with the track), thereby enabling the repositioning of the modules within the housing. It should be noted that several bioreactor assembly housings 135 may be stacked vertically (e.g., up to about six containers high), to accommodate the output of the effluent source by altering treatment capacity (discussed in greater detail below).

If desired, the cap assembly 105 and the bioreactor assembly 107 (i.e., the housing 135) may be supported on a support pad 142 such as a concrete pad.

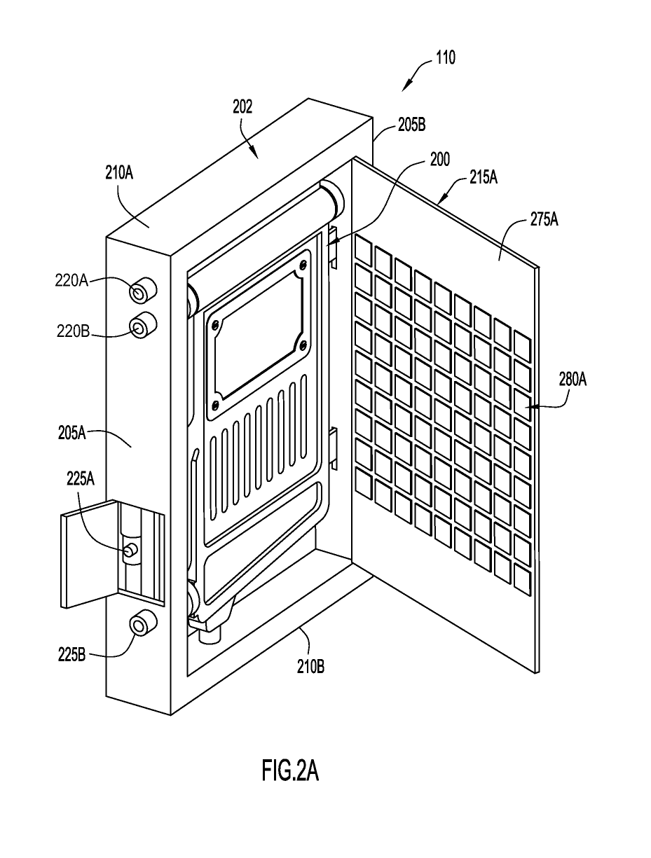

The bioreactor module 110 is configured to generate an algal biomass capable of removing contaminants (e.g., phosphorus, nitrogen, etc.) from the effluent 125 as it flows through the module. Referring to the embodiment illustrated in FIGS. 2A and 2B, a bioreactor module 110 includes a bioreactor unit 200 disposed within a housing 202. The housing 202 may generally rectangular, including a frame defined by a first side wall 205A, a second side wall 205B, a top wall 210A, and a bottom wall 210B. The housing 202 further includes a front or first access door 215A and a second or rear access door 215B, each door being movably coupled to the frame (e.g., a hinged door or panel removably secured via screws). The housing 202 further includes one or more fluid (air or water) ports in communication with the bioreactor unit 200 to permit the ingress of material into or the egress of material out of the bioreactor module 110. In the embodiment illustrated, the bioreactor module 200 includes an effluent inlet port 220A (coupled to intake line 134 (FIG. 1)), a pressurized fluid inlet port 220B, an effluent overflow or discharge port 225A, and a biomass discharge or harvesting port 225B. It should be understood that the bioreactor unit 200 may include any number of ports to permit addition of material two or extraction of material from the bioreactor unit 200. For example, the bioreactor module 110 may further include a gas inlet or outlet port (e.g., to add or remove CO₂).

The housing 202 may be formed of any material suitable for its described purpose. In an embodiment, the housing 202 is formed of material that permits that passage of light therethrough. By way of example, the housing 202 may be formed of transparent or translucent material (e.g., translucent plastic).

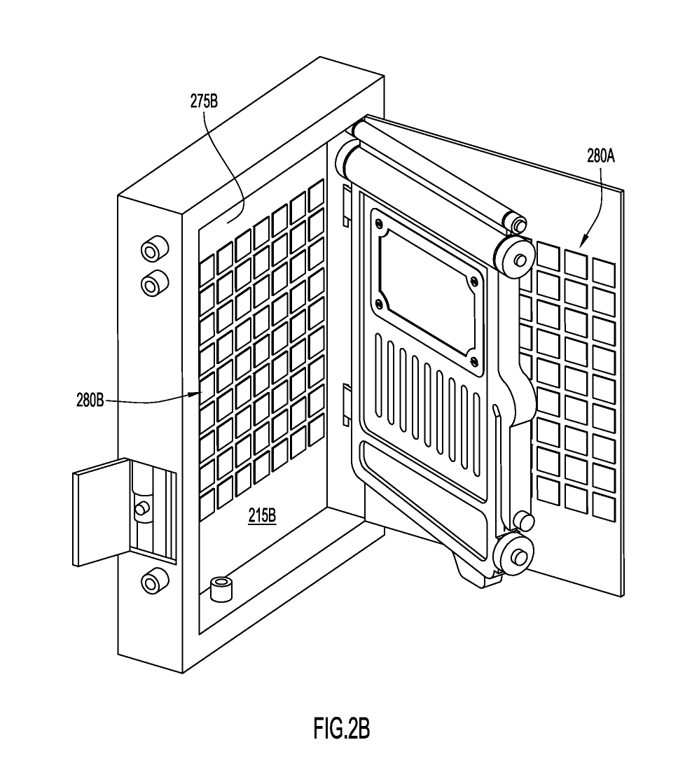

The bioreactor unit 200 may be supported within the housing 202 such that it is movable. As shown in FIG. 2B, the bioreactor unit 200 pivots with respect to the housing 202 to enable access to the unit. For this purpose, the bioreactor unit 200 may include one or more connectors 380 (FIG. 3) that pivotally couple to complementary connectors on the housing 202. In other embodiments, the bioreactor units 200 may move laterally along guide rails coupled to the upper wall 210A of the housing 202, providing a sliding door configuration that enables selective repositioning of the bioreactor units 200 within the housing 202.

The bioreactor unit 200 may be formed of any material suitable for its described purpose. In an embodiment, the bioreactor unit 200 or any of its components is formed of material that permits that passage of light (photons) therethrough. By way of example, the bioreactor unit 200 may be formed of transparent or translucent material (e.g., translucent plastic).

FIG. 3 illustrates an isolated view of the bioreactor unit 200 in accordance with an embodiment of the invention. As illustrated, the bioreactor unit 200 may be in the form of a tank including an upper or intake section 305, an intermediate or reaction section 310, and lower or harvesting section 315. The intake section 305 of the bioreactor unit 200 includes an upper, effluent supply housing 320 and a lower, dispersion housing 325. The housings 320, 325 may be separately or collectively covered in light blocking material 327 to prevent the premature formation of algae within the intake section 305. By way of example, the housings 320, 325 may be covered with a rubberized coating or paint, or may include a bonded lining.

The supply housing 320 includes an intake valve 330 that receives effluent 125 (via the inlet port 220A of the housing 202) and directs it to the dispersion housing 325. By way of example, the supply housing 320 may include piping with a series of holes formed along its bottom that would permit the effluent to a drop (e.g., via gravity) into the dispersion housing 325. Alternatively, the supply housing 320 may include piping that directly feeds the dispersion housing 325.

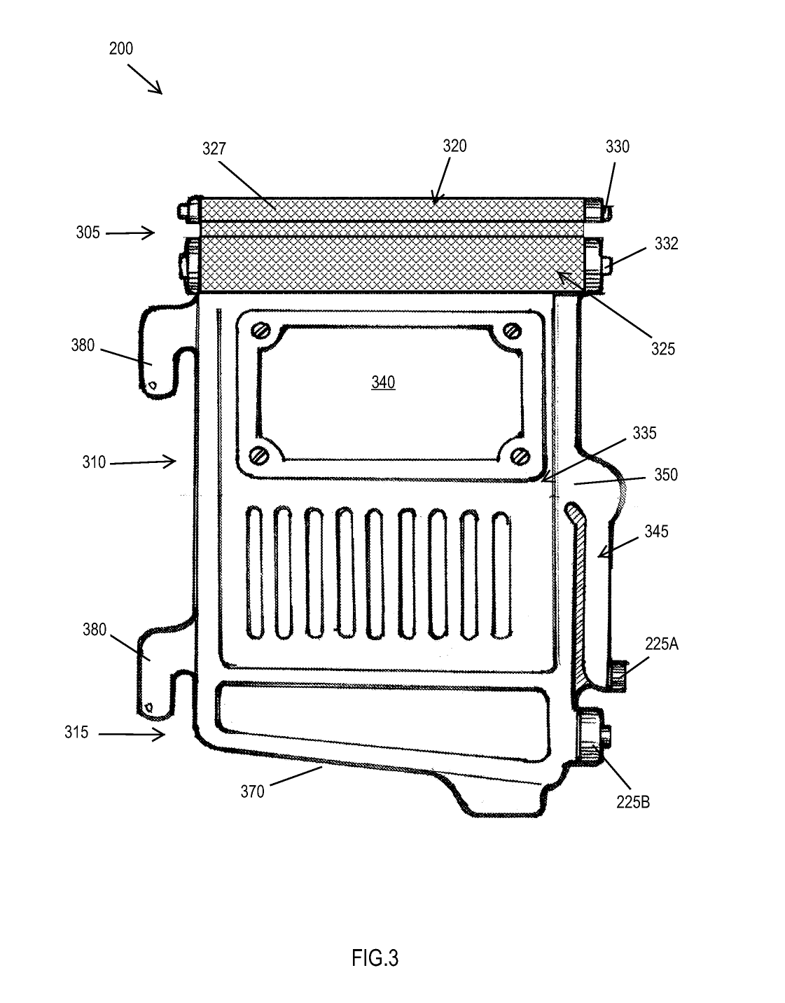

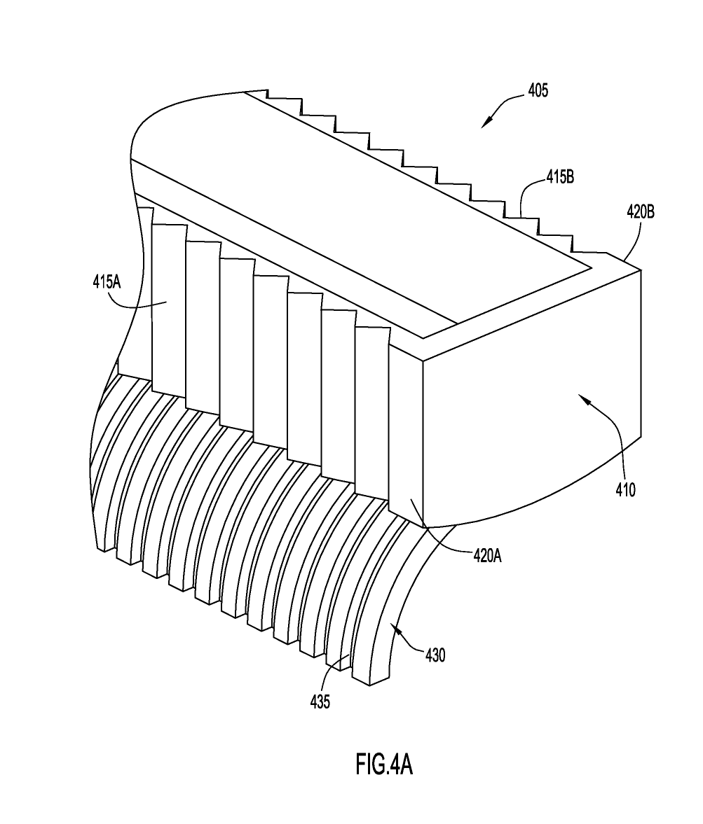

The dispersion housing 325 includes a dispersion device configured to disperse the effluent 125 generally evenly across the surfaces of the reaction substrate. Referring to FIG. 4A, the dispersion device 405 may be in the form of a trough 410 including a plurality of chutes or channels 415A, 415B formed along each of the front side 420A and the rear side 420B of the trough, respectively. The upper edge of each channel 415A, 415B may include a notch (e.g., a vertical, v-shaped notch (not illustrated)) to permit the escape of effluent 125 from the trough and into a channel. Alternatively, the notches alternate sides 420A, 420B to control fluid flow, selectively directing the effluent to predetermined locations.

The dispersion device 405 may further include a distribution plate 430 in fluid communication with the trough channels 415A, 415B. The distribution plate 430 may be a plate (e.g., straight or, as illustrated, curved) including a plurality of vertical grooves 435 formed into the surface of the plate. The grooves 435 are spaced laterally across the plate, and possess a shallow, predetermined depth operable to generate a thin laminar flow. The grooves 435 are configured to receive the effluent 125 along the upper edge of the plate (the edge proximate the trough 410), and then to generally evenly distribute the effluent across the width of the plate. Once the effluent 125 reaches the lower edge of the plate, adjacent streams exiting their corresponding grooves may combine, thereby forming a thin sheet of water that falls onto the substrate 500 (discussed in greater detail below). In other embodiments, the grooves 435 are laterally spaced such that individual streams exiting the grooves do not combine. In either construction, a gentle, cascading, laminar flow is generated and directed into the reaction chamber on onto the substrate.

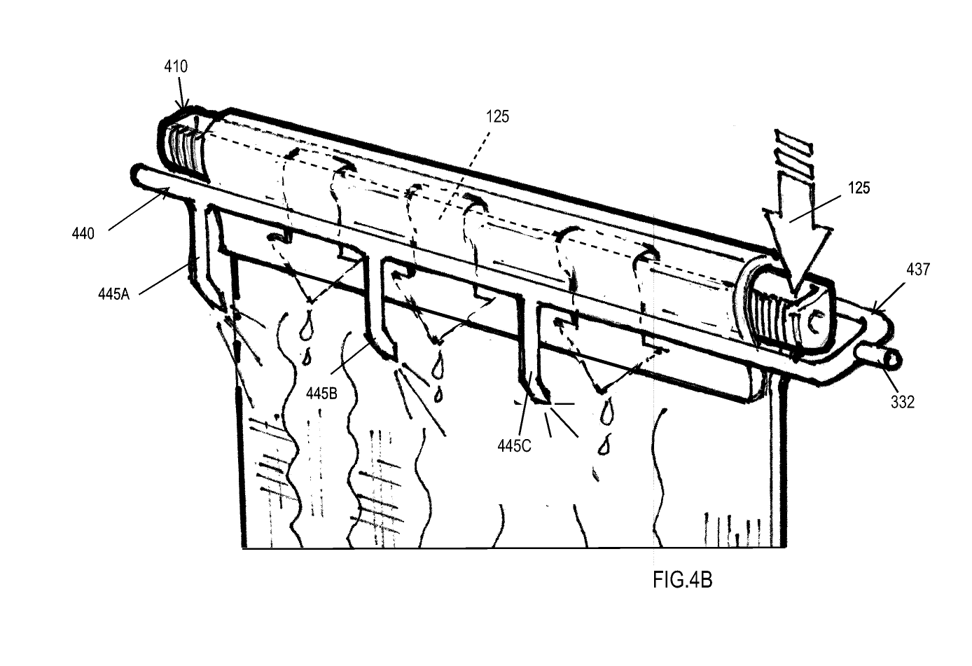

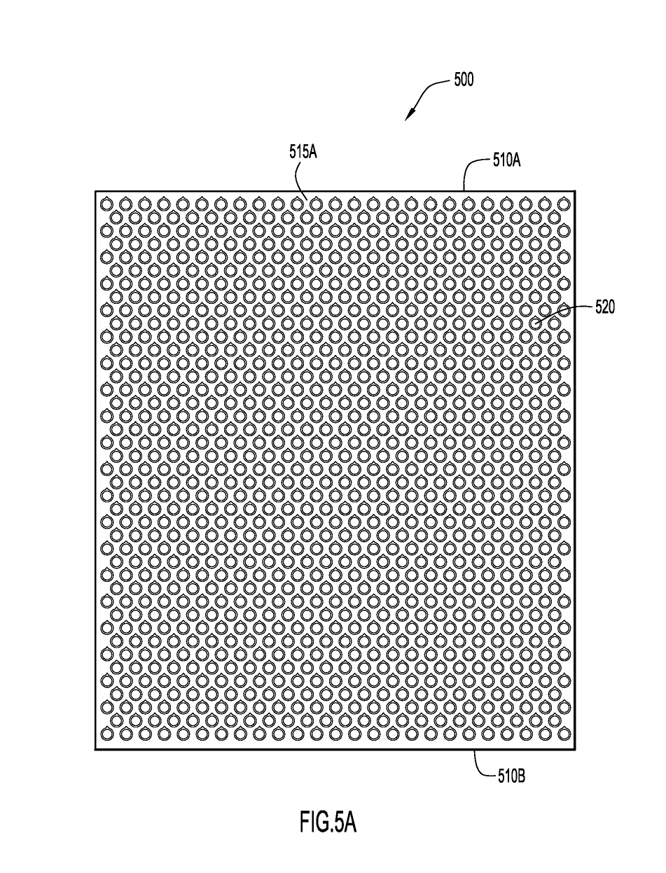

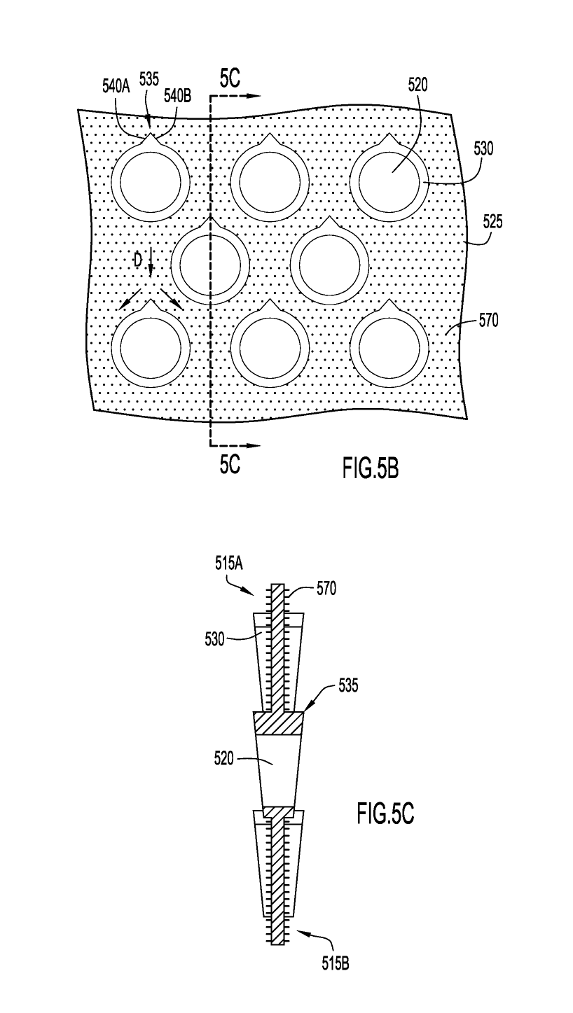

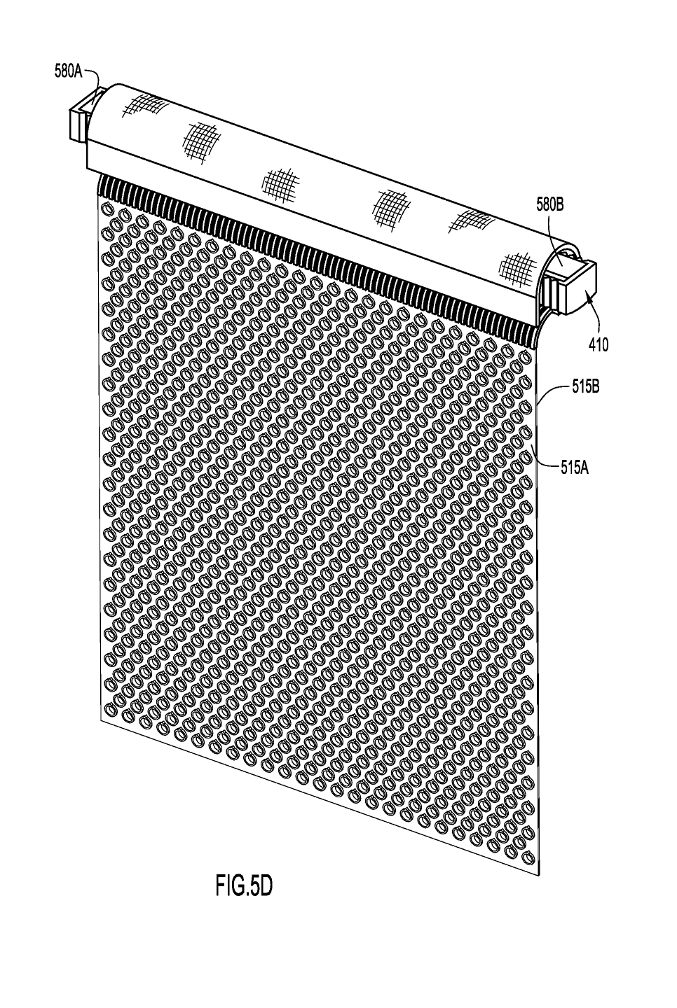

In operation, the effluent 125 flows into the supply housing 320, where it is directed through the piping in the dispersion housing 325 and into the trough 410 of the dispersion unit. The trough 410 fills with effluent 125, which falls over the sides of the trough and is directed into the trough channels 415A. The channels 415A divide the effluent 125, directing it downward, toward the distribution plate 430 (one disposed on each side of the trough). The distribution plate 430 further divides the effluent 125 to generate a thin sheet or film of effluent having a predetermined thickness. This thin sheet of effluent flows onto the substrate 500 (FIG. 5A). While a single distribution plate is illustrated, it should be understood that a second distribution plate similar to the one described may be positioned below the channels 415B on the rear side 420B of the trough 410.

Referring to FIG. 4B, the dispersion housing 325 may further include a cleansing device configured to dislodge the biomass and any other debris from the substrate 500 (FIG. 5A). As illustrated, the cleansing device 437 includes a conduit 440 in communication with a pressurized fluid source (via the valve 332 in fluid communication with inlet port 220B). The conduit 440 enters from a lateral side of the bioreactor unit 200, dividing and extending across the front side 420A and the rear side 420B of the trough 410. The fluid line 440 further includes a plurality of laterally spaced nozzles 445A, 445B 445C disposed at predetermined locations along the fluid line. Each nozzle 445A, 445B 445C extends downward, toward the substrate; accordingly, each nozzle is capable of directing a spray of pressurized fluid (e.g., water, air, or effluent) downward, toward the substrate. The sprays of fluid generate a force sufficient to dislodge any biomass that has formed on the substrate, thereby cleaning its surfaces.

As mentioned above, from the intake section 305, the dispersed effluent 125 flows into the reaction section 310. Referring back to FIG. 3, the reaction section 310 includes a reaction chamber 335 accessed via an access panel 340 oriented along the upper portion of the chamber (e.g. above the fluid line). The reaction chamber 335 further includes a discharge port 345 with an opening 350 that permits effluent to exit the reaction chamber 335. Accordingly, maintains the amount of effluent 125 at a predetermined level within the reaction chamber 335. The effluent 125 exiting the reaction chamber via the discharge port 345 (and thus the bioreactor unit 200) has been remediated. The discharge port 345 is in fluid communication with the outlet port 225A; consequently, it may be directed to storage containers, or may be sent downstream for additional processing (e.g., additional treatment), depending on the intended use of the decontaminated effluent.

A growth screen or substrate 500 is suspended in the reaction chamber 335. The growth screen provides a surface onto which the bacteria may settle, be captured, or be adsorbed, facilitating efficient algae growth. An important aspect of the system is that the substrate 500 maintains a substantially fixed position within the chamber; in addition, the substrate is oriented substantially vertically within the reaction chamber 335 to enable the flow of effluent 125 downstream, from its upper portion (proximate the trough) toward its lower portion (proximate the harvesting section). Accordingly, in an embodiment, the substrate 500 is generally rigid to minimize movement of the substrate within the reaction chamber. In another embodiment, the substrate is flexible (e.g., resiliently flexible), but is secured within the chamber 335 so that it maintains a generally fixed position.

Referring FIGS. 5A-5D, the substrate 500 may be in the form of a generally rectangular panel, having a first transverse or top edge 510A and a second transverse or bottom edge 510B, and defining a first or forward side 515A and a second or rearward side 515B. The substrate 500 may further includes a plurality of apertures 520 to permit movement of fluid (e.g., the flow of effluent 125 and/or air) around the substrate 500, thereby improving biomass formation. The apertures 520 may possess any size suitable for its described purpose. By way of example, the apertures 520 may possess a diameter of about 50 microns to about 5 millimeters (e.g., approximately 1-3 millimeters). In a preferred embodiment, the apertures 520 possess a diameter of at least about 1.5 mm (e.g., 0.0625 inches). In addition, the apertures 520 may possess any shape suitable for its described purpose. By way of example, the apertures 520 may be circular, polygonal, etc. It should be noted that the substrate may include apertures 520 of uniform size and/or shape, or may include apertures of varying sizes and/or shapes. The number, size and layout of the apertures 520 are selected to provide a consistent flow of effluent across the surfaces of the substrate 500. Additionally, along generating a desired flow down the substrate, the apertures 520 improve the dispersion of light energy within the chamber 335, as well as increase the available surfaces onto which the bacteria may be adsorbed. These, in turn, maximize formation of the algal biomass.

In another embodiment, the substrate 500 is modified to further improve fluid dynamics along its surfaces. As illustrated, one or more apertures 520 may further include a grommet or rib 530. As shown, the grommet 530 is a raised lip disposed about the periphery of the aperture 520 on each surface 515A, 515B to define a raised edge. The rib 530, which is generally rounded, protrudes from the surface 525 of the substrate 500. In an embodiment, the rib 530 is generally uniform, protruding from the substrate surface 525 at a uniform distance along its extent. In another embodiment, as shown in FIG. 5C, rib 530 tapers inward toward in the direction of the bottom substrate edge 510B. That is, the rib 530 tapers inward such that the upper portion of the rib protrudes a greater distance from the substrate surface than the lower portion of the rib, gradually lessening the degree of protrusion toward the bottom of the aperture 520. In another embodiment, the lower portion of the rib 530 tapers such that it is flush with the substrate surface 525.

Additionally, the upper portion of the rib 530 may include a deflection ramp or fin 535 having first inclined surface 540A and second inclined surfaces 540B opposite the first inclined surface. The inclined surfaces 540A, 540B are configured to deflect the flow of effluent 125 outward, along the sides of the aperture 520 (indicated by arrows D). This configuration not only improves fluid flow down the sides 515A, 515B of the substrate, but also creates turbulence in the flow, generating a slight mixing motion in the effluent 125 to encourage adsorption of bacteria and algal growth.

In another embodiment, the substrate 500 does not include the ribs and instead only includes the apertures. As such the substrate surface 525 is generally planar on each of the first side 515A and the second side 515B.

The surface 525 of the substrate 500 may be modified to increase adsorption of bacteria and, as such, the formation of a biomass. Specifically, the substrate 500 may possess a roughened or textured surface. That is, the surface 525 of the substrate 500 may be modified such that it possesses a plurality of deviations 570 (cavities, projections, or other topographical irregularities or imperfections) that increase the overall surface roughness value of the substrate. In another embodiment, the deviations may be in the form of filaments extending distally from the surface 525 of the substrate 500. The deviations 570 provide a greater number of adsorption sites for bacteria (compared to that of a smooth surface or a surface possessing a lower surface roughness value), improving the formation of the algal biomass. In addition, the irregularities generate turbulence in the fluid flow, creating a mixing action beneficial to algal growth.

The substrate 500 may be formed of plastic such as high density polyethylene or polypropylene. The material forming the substrate, moreover, may transparent or translucent.

In an embodiment, the upper edge 510A of the substrate 500 is coupled to the trough 410, being connected to the lower edge of the dispersion plate 430A, 430B or being connected to the trough 410 proximate the trough channels (one substrate on each side of the trough). In addition, as shown in FIG. 5D, the substrate 500 is wrapped around the trough 410, possessing a lateral dimension (width) that is less than length of the trough 410 to form lateral openings 580A, 580B along opposite sides of the substrate. The openings enable the flow of effluent 125 into the trough 410 from the supply housing 320. With this configuration, the effluent 125 enters the trough channels, falling through onto the substrate.

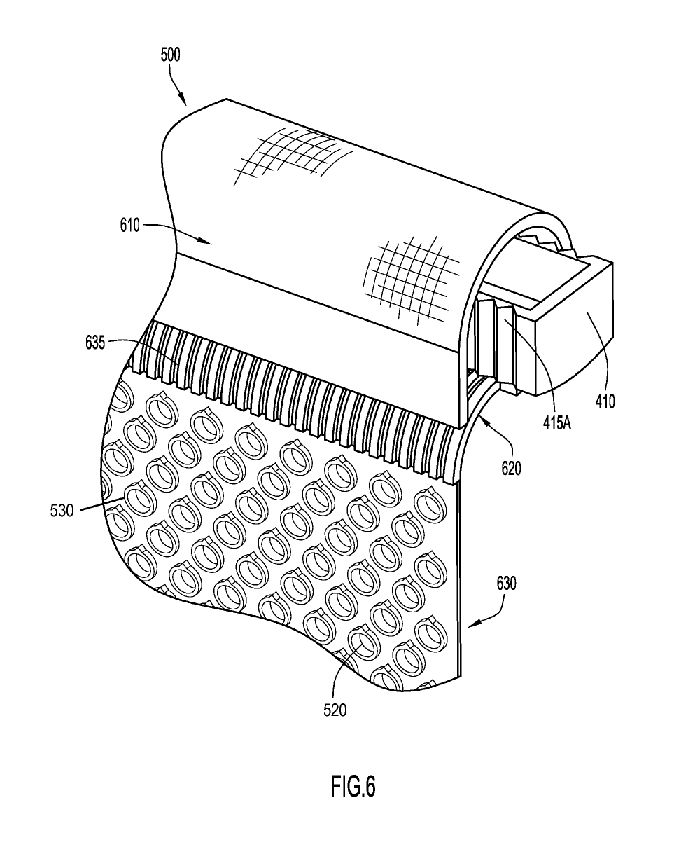

Referring to FIG. 6, in an embodiment, the distribution grooves are formed integrally with the substrate 500. As shown, the substrate 500 includes a proximal, upper section 610, an intermediate, grooved section 620, and a lower, distal section 630. The proximal section 610 is generally flexible, comprising an open mesh material (or alternatively, a plurality of apertures). The distal section 630 includes the apertures 520 as described above and, accordingly, defines the primary growth surface of the substrate 500.

The grooved section 620 is disposed proximate the trough 410 such that the effluent 125 exiting the trough channels 415A is discharged onto the grooved section 620. The grooved section 620 includes a plurality of generally-vertical-oriented grooves 635 spaced laterally across the substrate 500. The grooves 635 possess a shallow, predetermined depth operable to generate a thin laminar flow. The grooves 635 are configured to receive the effluent 125 along the upper edge of the section (proximate the trough 410), and then to generally evenly distribute the effluent across the width of the substrate. With this configuration, a generally even, cascading flow is generated and directed into the reaction chamber on onto the substrate.

With this configuration, the distal section 630 defines the primary algal growth surface of the substrate 500, with the grooves 635 dispersing the effluent across the entire surface of the substrate, maximizing algal growth.

Referring back to FIG. 3, the harvesting section 315 of the bioreactor unit 200 enables the collection and harvesting of the formed algal biomass. As shown, the harvesting section 315 forms the lower portion of the reaction chamber 335. The harvesting section 335 may include an angled floor 370 configured to direct the biomass toward the harvesting outlet 225B. The harvesting outlet may be in communication with a pump or vacuum that draws the biomass from the bioreactor module 110. Additionally, the biomass may be collected manually from the harvesting section 335.

Referring back FIGS. 2A and 2B, the bioreactor unit 200 is further configured to generate and direct photons into the reaction chamber and, in particular, toward each side 515A, 515B of the substrate 500. As illustrated, the interior surface 275A of the first door 215A of the housing 202 includes a first light array 280A, while the interior surface 275B of the second door 215B includes a second light array 280B. In an embodiment, the light arrays 280A, 280B are light emitting diode (LED) panels including a plurality of light sources operable to independently or collectively generate light having a predefined wavelength. By way of example, the LED panel may include an array of alternating blue LEDs and red LEDs. By way of further example, the blue LEDs may be configured to produce light having a wavelength of about 440-490 nm (e.g., about 475 nm), while the red LEDs may be configured to produce light having a wavelength of about 630 nm-740 nm (e.g., about 650 nm). Lights having these wavelengths are preferred for their ability to encourage algae growth, without damaging the produced algal biomass. In an embodiment, each array 280A, 280B may include a 50/50 ratio of red and blue LEDs. Each array 280A, 280B may cover all or a portion of the panel interior surface 275A, 275B.

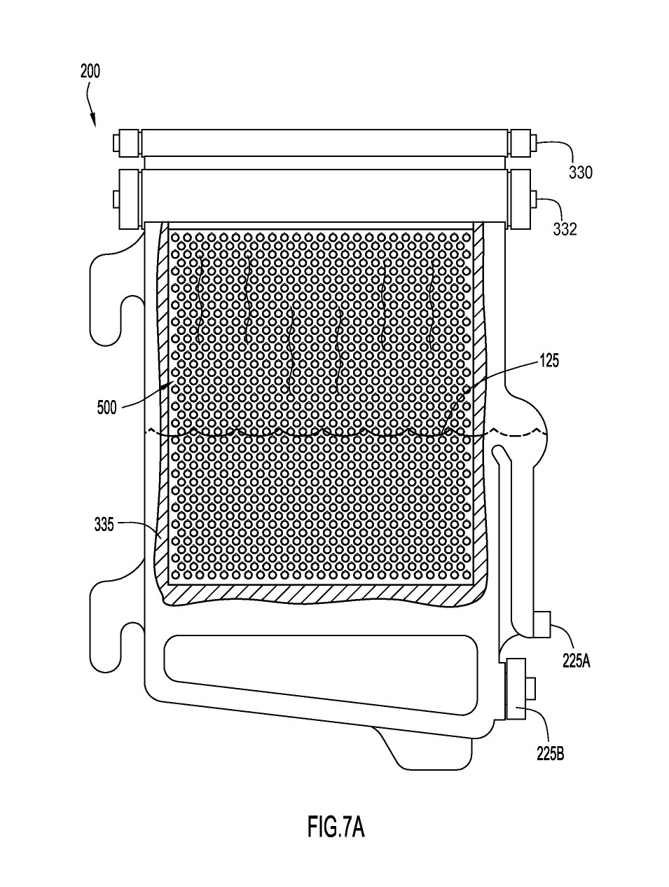

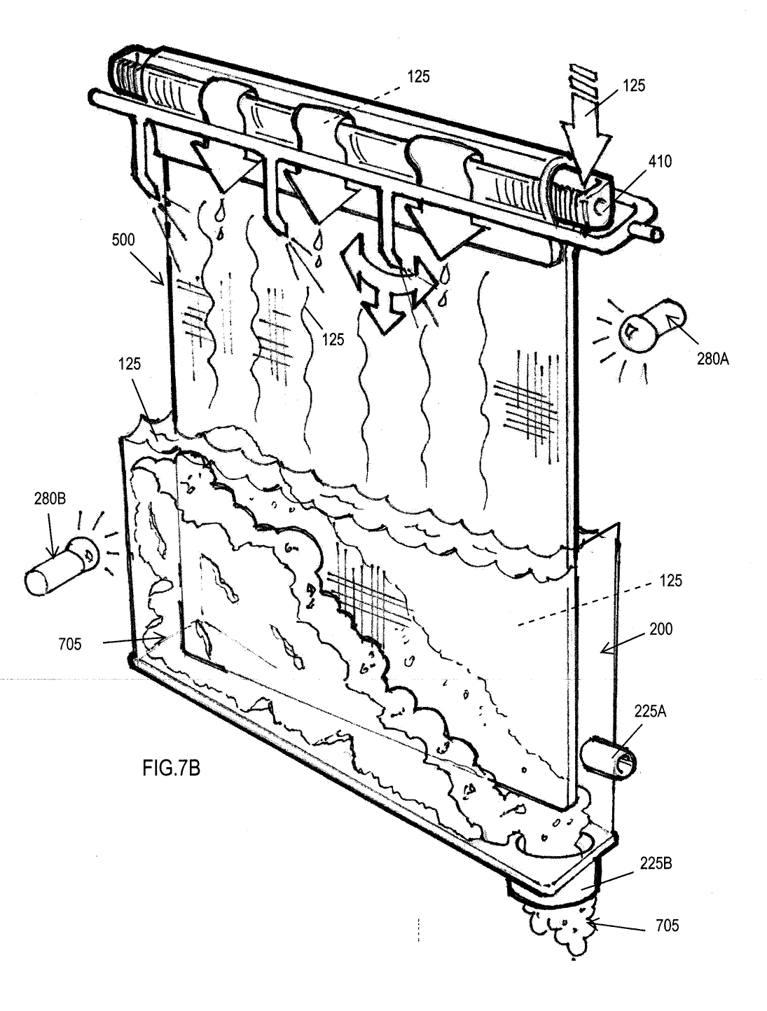

The operation of the bioreactor module 110 is explained with reference to FIGS. 1, 7A and 7B. The nutrient-rich effluent 125 is drawn into the cap assembly 105 and, if necessary, pre-treated as described above. The effluent 125 is pumped into the bioreactor assembly 107, where it is delivered to each bioreactor module 110 present within the bioreactor assembly. The effluent 125 enters the supply housing 320, traveling to the dispersion housing 325 and forming a cascading flow of effluent, as described above.

The cascading effluent 125 is directed onto the surface 525 of the substrate 500, filling the lower portion of the reaction chamber 335 to partially submerge the substrate. As a result, indigenous microorganisms (e.g., bacteria) from the effluent 125 settle onto the substrate surface 525 (e.g., into the deviations 570).

As the effluent 125 cascades over the substrate 500 and slowly fills the reaction chamber 335, the LED arrays 280A, 280B are engaged (either simultaneously or individually) for a predetermined period of time (e.g., 12 hours on, 12 hours off). Alternating illumination periods allows the bacteria or other microorganisms to recover after accepting a photon, improving algae growth.

As a result, indigenous microorganisms (e.g., bacteria) from the effluent 125 are adsorbed onto the substrate surfaces 525 (along each side 515A, 515B) and gradually develop (grow) into a biomass 705 (also called a microbial mat). The biomass 705 is formed of bio-diverse communities of unicellular to filamentous microbes of all major algal phyla living together. The algae produce oxygen necessary for aerobic bacterial growth, while the bacteria produce CO₂ necessary for algal growth. The only external input to fuel this reaction is light (either naturally occurring sunlight or artificial light), which, at the very least, is provided by arrays 280A, 280B. The algae capture CO₂ and N₂ from the effluent 125 (and/or from air within the reaction chamber), as well as capture light (from the LED arrays). This biomass 705 cleans the effluent 125, being capable of consuming salts, phosphates, calcium, magnesium, ammonia, nitrates, and/or other contaminants present within the effluent.

The biomass 705 continues to grow on the substrate 500, ultimately becoming too heavy to support itself on the substrate surface 525, falling from the substrate 500 and collecting in the harvesting section 315 of the bioreactor unit 200. To accelerate the removal of the biomass 705 from the substrate 500, the pressurized fluid system may be engaged to generate sprays with sufficient force to dislodge the biomass (as described above). By way of example, the pressurized fluid may be engaged at regular intervals for predetermined periods of time (e.g., every seven days for 12 minutes). Alternatively, the biomass 705 may be manually dislodged from the substrate 500. Since the harvesting section 315 is typically oriented below the fluid line, the biomass 705 gathering within the harvesting section is submerged in the effluent 125. Accordingly, the biomass 705 will continue to grow, removing contaminants from the effluent.

The biomass 705 may be harvested periodically (e.g., every seven days) to maintain high levels of productivity. The harvested material may then be processed to extract desired components from the material. This harvested material is rich in bio oil, protein, cellulose, and oxygen O₂.

As mentioned above, algae use water, CO₂ and sunlight to grow. The bacterial colonies present in the effluent 125 ingest the oxygen produced by the algae and emit CO₂, which is utilized by the algae. In order to sustain a desired level of algae growth, it may be desirable to introduce additional CO₂ into the reaction chamber to augment that generated by the bacterial colonies. Accordingly, the bioreactor may be in fluid communication from an external CO₂ source, entering via a port 710 disposed along a lower portion of the reaction chamber. In addition to augmenting the level of CO₂, injection of a fluid such as a gas into the reaction chamber further circulates the algae and bacteria, encouraging additional reactions.

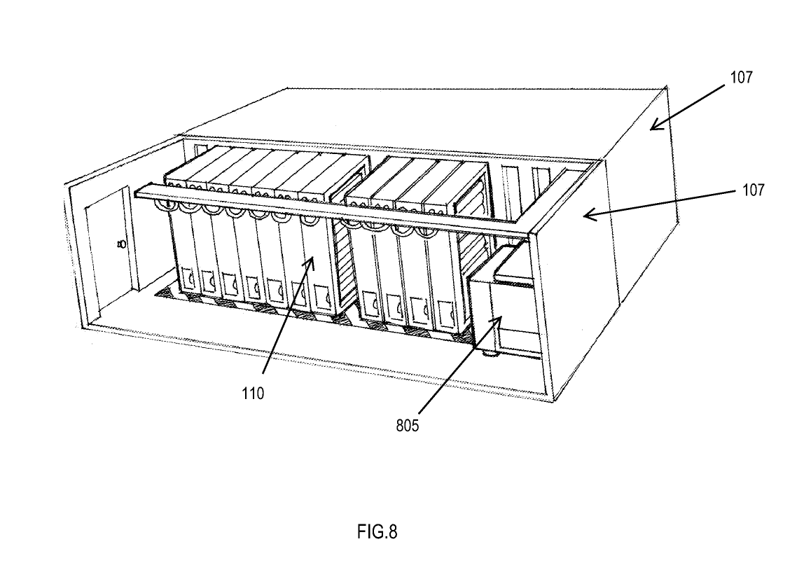

Once the biomass 705 is harvested, it may be processed in a desired manner. Referring to FIG. 8, the system 10 may further include a drying and separation unit 805 located downstream from the bioreactor assembly 107 (e.g., in fluid communication with the bioreactor assembly 107 via the harvesting port 225B). The drying and separation unit 805 may utilize ultrasound to break cell walls and separate the oil from the biomass. The protein-rich biomass 705 may then dried, e.g., by utilizing the geothermal heat from the effluent 125. In other embodiments, the harvested biomass 705 may be collected and processed off site.

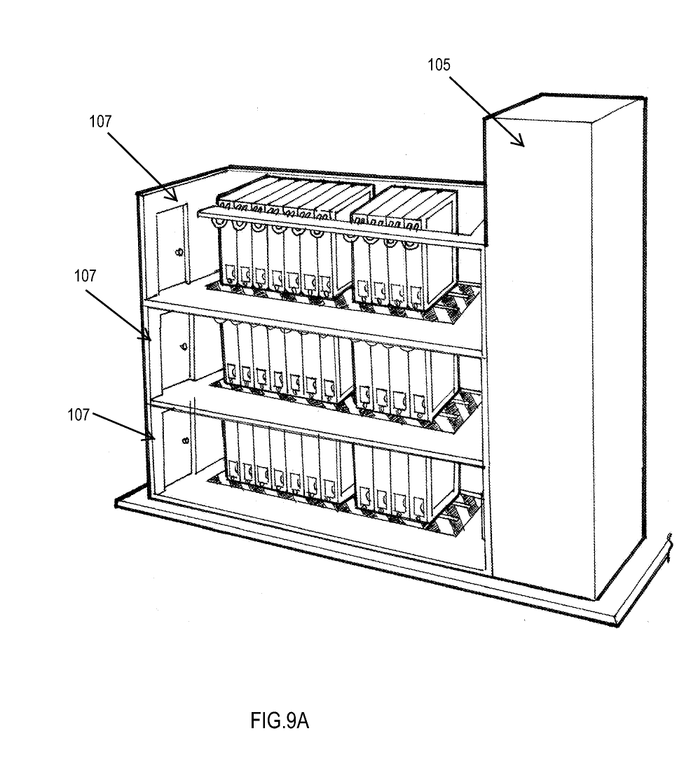

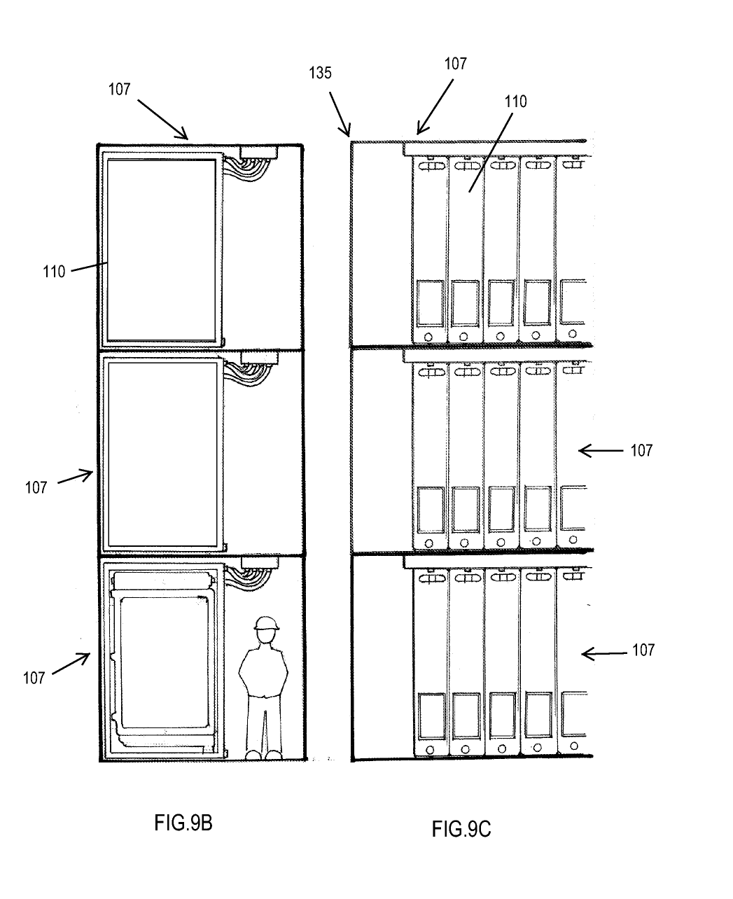

The above described system 10 may be configured as a modular system to accommodate varying discharge volumes. That is, a plurality of bioreactor modules 110 and/or bioreactor assemblies 107 may be connected in series or in parallel to accommodate wells of various output volumes. Referring to FIGS. 1 and 9A-9C, a plurality of bioreactor modules 110 may be housed in one or more bioreactor assembly housings 135. The bioreactor assembly housings 135 may be stacked vertically up to about six containers high to facilitate a high volume of bio-oil production per acre (FIG. 5B). As noted above, each bioreactor module 110 is in fluid communication with the cap assembly 105. Accordingly, the effluent 125 is divided among the storage reactors. Should the output of the effluent source change (e.g., should the well output increase or decrease), additional bioreactor modules 110 may be added or removed in situ. That is, a bioreactor module 110 may be brought online or taken off line without disturbing the normal operation of the other modules in the system.

Within the system, the bioreactor modules 110 may be installed in a fashion similar to that of a records storage shelving system, fitting flush together. In addition, the bioreactor modules 110 can be pulled out individually for service and/or maintenance. To maximize bio-oil production, a combination of bioreactor assemblies 107 (configured to grow algae) and cap assemblies 105 (configured to re-circulate the water and treat it prior to flowing it into the reactor module) may be utilized. By way of specific example, a ratio of six bioreactor assemblies 107 (each including 10 bioreactor modules 110) may be utilized for one cap assembly 105. With this configuration, the present system enables growth over 100,000 gallons of bio-oil per acre per year, which is approximately 20 times the productivity of pond based algae systems.

The treatment system of the present invention provides a highly efficient system for processing geofluids such as produced water, flowback, and other discharge from geothermal formations. The algae use a combination of photons, heat, and the nutrient-rich effluent to grow to a high lipid density. The system attributes—including water flow, light, and regular harvesting—generate a microbial mat that is highly efficient at capturing light and geothermal energy. The increased efficiency of the microbial mats provided by the system is related, in part, to the high levels of mixing caused by the generated water flow. Flowing effluent, forced against cells by surge (via the dispersion conduit 325), greatly increases chemical exchange. In addition, the back and forth swashing of filaments in the water surge causes individual cells to receive the photons of the light arrays (no cells are fully shaded by others). This allows a very high level of light capture, and typically, there is no light inhibition (most individual cells of the microbial mats are photosynthetic). In many higher plant and planktonic algal cells, photosynthesis is biochemically inhibited in full sunlight, especially at high temperatures. The typical problems of terrestrial plants such as water loss, stomate closure, and CO₂ cut-off does not occur.

The present system is ideally suited for treating geothermal fluids (also called geofluids), such as those fluids released during fracking. It is believed that the relationship of algae growth rate from light intensity is temperature dependent. Generally, as the temperature increases, the saturation intensity increases, resulting in a higher algal growth rate. Geothermal fluids, moreover, contain high amounts of nutrients, including carbon, containing one or more of Silica (SiO₂), Sodium (Na), Potassium (K), Calcium (Ca), Magnesium (Mg), Carbonate (CO₃²⁻), Sulfate (SO₄), Hydrogen Sulfide (H₂5), Chloride (Cl), Fluoride (F), Iron (Fe) Manganese (Mn), Boron (B), Hydrogen (H₂), and Aluminum (Al). Accordingly, by providing photon energy to an effluent 125 possessing thermal energy such as a geofluid (the fluid is expelled from the source in a heated state), the growth rate of the biomass can be maximized. In addition, by controlling the frequency, intensity, and duration of the light source growth of the biomass can be further enhanced.

Thus, the present treatment system enables a very high proportion of light energy captured to be transferred to chemical storage as added biomass. The growth screen 500 allows red and blue light to enter the enclosed environment, while containing gases and biomass. Each bioreactor facilitates the growth of algae and an LED light source that provides light to both sides of the substrate. The resulting microbial mats are only very weakly inhibited by low nutrient levels. Individual cells are able to uptake carbon, nitrogen and phosphorus at fractions of ppb levels. Since the effluent film adjacent to each cell cannot be exhausted of nutrients in a water surge and flow environment, relatively high levels of productivity occur even at very low nutrient concentrations.

The design of the reaction chamber 335, furthermore, allows effluent 125 to collect around base of the screen, encouraging growth and increasing the amount of biomass 705 produced by having both the substrate growth and water volume growth occur vertically. The geothermal energy within the geofluid is generally constant (i.e., there is no seasonality in light or temperature (70° F.)), creating an environment beneficial for algae growth.

The present system is capable of providing continuous algae growth as long as effluent and a light source are available. The system, moreover, possesses a smaller footprint than conventional waste processing approaches. The ability to provide high volume waste treatment within a small area of land makes on-site treatment more readily available since it avoids input of capital into large areas of land. In addition, the present invention provides a standardized modular design (e.g., based on the form factor of a shipping container), allows the system capacity/production to be rapidly increased. The enclosed design enables growth of oil rich algae 20 times that of open-air pond based processes.

While the invention has been described in detail with reference to specific embodiments thereof, it will be apparent to one of ordinary skill in the art that various changes and modifications can be made therein without departing from the spirit and scope thereof. For example, the treatment system may be utilized with a variety of effluent sources such as agricultural, industrial, municipal, and other wastewater sources. The effluent may undergo additional treatment either before or after treatment in the bioreactors. The algae bio-solid byproducts may be processed as needed for use as bio-fuel, fertilizer, and animal feed additives.

The bioreactor module may be any shape and may possess any dimensions suitable for its intended purpose. By way of example, the reactor modules may possess dimensions of 90″ L×51″ W and 3″ D. Similarly, the substrate may be of any shape and possess any dimensions suitable for its described purpose. By way of example, each substrate may provide two surfaces, each surface having dimensions of 75″ L×41″ W. The bioreactor module may include any number and type of connection ports in addition to those already described. By way of example, connection ports that allow water, nutrients, microbial drainage, gas injection, and harvesting may be provided.

The dispersion device may be any device configured to disperse the effluent across each substrate surface. By way of example, instead of the illustrated trough, the dispersion device 405 may be in the form of a cylinder coupled to the upper edge of the substrate 500, spanning the substrate's width. The cylinder generates surface tension sufficient to disperse the effluent falling from the supply housing 320. In an embodiment, the dispersion device includes a channel along its upper edge into which the falling fluid initially collects. With this configuration, the dispersion member pulses a thin sheet of effluent (e.g., about 1-2 cm thick) across each surface of the substrate.

Accordingly, it is intended that the present invention covers the modifications and variations of this invention provided they come within the scope of the appended claims and their equivalents.

We claim:

1. A system for treating an effluent from an effluent source, the system comprising a bioreactor assembly including at least one bioreactor module, the bioreactor module comprising:
a housing including an inlet to receive effluent discharge by a source;
a substrate substantially fixed within the housing, the substrate comprising:
a screen defining an algal growth surface, the algal growth surface being oriented generally vertically within the housing,
a plurality of apertures formed into the screen, the apertures permitting passage of fluid through the substrate; and
a light source operable to direct photons toward the algal growth surface,
wherein the effluent is directed onto the substrate such that it travels downstream from an upper portion of the growth surface to a lower portion of the growth surface, the effluent flowing over the growth surface to generate an algal biomass thereon.

2. The system of claim 1, wherein the apertures possess a diameter of approximately 1.5 mm or more.

3. The system of claim 1 further including a dispersion device oriented above the growth surface, the dispersion device comprising a trough including a wall defining a cavity to receive the effluent and one or more trough channels formed into an exterior surface of the wall, the trough channels directing the effluent within the cavity toward the substrate growth surface.

4. The system of claim 1, further comprising a cap assembly in fluid communication with the inlet of the bioreactor module, the cap assembly operable to receive effluent from the source and to direct the effluent downstream to the bioreactor module.

5. The system of claim 4, wherein the cap assembly includes a cap and a cap housing disposed over the cap, the housing capable of storing the effluent for a predetermined period of time before directing the effluent downstream toward the bioreactor module.

6. The system of claim 1, wherein the bioreactor module further comprises cleansing device for dislodging biomass formed on the substrate, the cleansing device in fluid communication with a pressurized fluid source, the cleansing device comprising one or more nozzles configured to generate a stream of fluid toward the growth surface.

7. The system of claim 1, wherein:
the housing includes a chamber operable to hold a volume of effluent; and
the substrate is positioned within the housing such that the substrate is partially submerged in the volume of effluent.

8. The system of claim 7, further comprising an effluent outlet to permit the flow of effluent out of the chamber, the outlet disposed at an intermediate vertical location along the housing.

9. The system of claim 1, wherein the growth surface defines a textured surface, the textured surface defined by a plurality of projections and cavities formed into the substrate.

10. The system of claim 1, wherein one or more of the apertures are defined by a raised rib protruding from a surface of the substrate, the rib being configured to direct at least a portion of the effluent around the aperture as the effluence flows down the substrate.

11. The system of claim 1, wherein the raised rib further comprises a deflection ramp extending distally from the raised rib, the raised rib including opposed inclined surfaces.

12. The system of claim 1, wherein the light source comprises a first LED array and a second LED array, the LED arrays disposed on opposite sides of the substrate, wherein the LED arrays are configured to selectively generate light having a first wavelength of 440-490 nm and a second wavelength of about 630 nm-740 nm.

13. The system of claim 1, wherein the effluent source is a geothermal fluid source.

14. A method of treating contaminated liquid effluent from a source, the method comprising:
receiving liquid effluent discharged from a source into a cap assembly;
directing the liquid effluent from the cap assembly an into a reaction chamber, the reaction chamber including:
a substrate defining an algal growth surface oriented generally vertically within the reaction chamber, the substrate defining a plurality of apertures, wherein the substrate is substantially fixed within the reaction chamber, and
a light source operable to generate light having a predetermined wavelength toward the algal growth surface;
generating a biomass on the algal growth surface by directing the liquid effluent across the algal growth surface and selectively activating and disengaging the light source,
wherein biomass consumes at least one contaminant from the effluent.

15. The method of claim 14, further comprising harvesting the biomass from the reaction chamber.

16. The method of claim 15, further comprising drying the harvested biomass in a dryer unit and separating the biomass into components.

17. The method of claim 14, wherein the substrate comprises a plurality of grooves oriented above one or more of the plurality of apertures, the grooves dispersing the liquid effluent across the substrate.

18. The method of claim 14, wherein:
the reaction chamber further comprises a dispersion device disposed above the algal growth surface, the dispersion device operable to disperse the effluent across the substrate; and
the method further comprises directing the liquid effluent into the dispersion device.

19. The method of claim 14, wherein the liquid effluent is a geothermal fluid.
